(19) United States
(12) Patent Application Publication
(10) Pub. No.: US 2020/0399005 A1
(43) Pub. Date: Dec. 24, 2020

(54) Spray Devices For Dispensing Aqueous Iodine, and Methods of Making and Using Spray Devices That Dispense Aqueous Iodine

(71) Applicant: Terragenx Inc., Quebec (CA)

(72) Inventor: Terence Francis Mullins, Quebec (CA)

(21) Appl. No.: 15/733,542

(22) PCT Filed: Feb. 27, 2019
(86) PCT No.: PCT/CA19/50232

§ 371 Date: Aug. 24, 2020

Related U.S. Application Data
(60) Provisional application No. 62/636,012, filed on Feb. 27, 2018.

(51) Int. Cl. B65B 55/00; B05B 11/00; B65D 83/00

(52) U.S. Cl. CPC B65B 55/00; B05B 11/0097; B05B 11/3074; B65D 83/0033; B05B 11/00416

(57) ABSTRACT

Spray devices that have been preconditioned with an iodine-containing conditioning agent prior to being deployed with aqueous iodine. In some embodiments, each spray device contains one or more materials that will be wetted by the aqueous iodine during use and that have been preconditioned to contain iodine so as to inhibit iodine absorption from the aqueous iodine added to the spray device after the preconditioning. Methods for preconditioning spray devices are also disclosed. In one example, surfaces of spray-device components that will be wetted by aqueous iodine during deployment are exposed to an iodine-containing conditioning agent and, while exposed to the iodine-containing conditioning agent, are thermodynamically treated. Methods of using spray devices for dispensing aqueous iodine for any one or more of a variety of purposes are also disclosed.

### RELATED APPLICATION DATA

This application claims the benefit of priority of U.S. Provisional Patent Application Ser. No. 62/636,012, filed Feb. 27, 2018, and titled “Aqueous Iodine Dispensing Device,” which is incorporated by reference herein in its entirety.

### FIELD OF THE INVENTION

The present invention generally relates to the field of dispensing devices for iodine-containing liquids. In particular, the present invention is directed to spray devices for dispensing aqueous iodine, and methods of making and using spray devices that dispense aqueous iodine.

### BACKGROUND

Iodine is recognized as an essential human micronutrient, because every cell in our bodies need it to function properly. Iodine is also utilized by the human thyroid to create essential hormones for brain development, immune system function, and regulating metabolism to mention but a few human requirements. Iodine can also kills cancer cells in our bodies.

Iodine is further a recognized and approved world-class medical disinfectant; for example, it kills bacteria, viruses, and fungi. Iodine is currently sold in complexed molecular forms, such as iodophor (e.g., BETADINE® antiseptic available from Avrio Health Products LP, Stamford, Conn.) or tinctures for topical applications. The only active ingredient in these products is iodine. Iodine in a complexed form requires additional chemical components, including plastics, surfactants, and alcohols within the matrix, and these additional components are often not suitable for consumption and new applications. These solutions to tame or stabilize so called “wild iodine” were created in the 1950s. Tamed iodine unfortunately reduced the applications where iodine could be used.

### SUMMARY OF THE DISCLOSURE

In one implementation, the present disclosure is directed to a method of preparing a spray device for dispensing aqueous iodine, when assembled the spray device includes a body defining a chamber and containing a reservoir for holding the aqueous iodine, wherein the reservoir comprises walls having interior surfaces wetted by the aqueous iodine when the aqueous iodine is present in the reservoir; and a sprayer in fluid communication with the reservoir, the sprayer having surfaces wetted by the aqueous iodine during use of the spray device when the aqueous iodine is present in the reservoir. The method includes exposing the interior surfaces of the walls of the reservoir to an iodine-containing conditioning agent; exposing the surfaces of the sprayer, to the iodine-containing conditioning agent; thermodynamically treating the body and the sprayer while the interior surfaces of the reservoir and the surfaces of the sprayer are exposed to the iodine-containing conditioning agent; and removing the iodine-containing conditioning agent from the reservoir prior to filling the reservoir with the aqueous iodine.

In another implementation, the present disclosure is directed to a spray device that includes a body defining a chamber and containing a reservoir for holding the aqueous iodine, wherein the fluid reservoir has walls wetted by the aqueous iodine when the aqueous iodine is present in the reservoir, at least one of the walls comprising a polymer containing sorbed iodine from an iodine-containing preconditioning agent at least in regions adjacent to the reservoir; and a sprayer having a fluid-passageway in fluid communication with the reservoir and wetted by the aqueous iodine when the aqueous iodine is present in the reservoir and the spray device is in use, the sprayer comprising a polymer containing sorbed iodine from the iodine-containing preconditioning agent at least in regions adjacent to the fluid passageway.

In yet another implementation, the present disclosure is directed to a method of assisting a user with administering iodine. The method includes providing a spray device containing aqueous iodine and having a sprayer, the aqueous iodine having an iodine content of 300 parts per million or lower and the sprayer dispensing a fixed amount of the aqueous iodine from the spray device per each full activation of the sprayer; providing the user with a visual indication of at least one of the fixed amount of aqueous iodine dispensed per each full activation of the sprayer; a recommended dosage; an amount of iodine dispensed per each full activation of the sprayer; and a number of full activations of the sprayer corresponding to the recommended dosage.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating an example method of preconditioning a spray device for containing and dispensing aqueous iodine;

FIG. 2 is a partial cross-sectional view and partial side view of an example piston-type airless sprayer for containing and dispensing aqueous iodine;

FIG. 3 is a partial cross-sectional view and partial side view of an example piston-type airless sprayer for containing and dispensing aqueous iodine; and

FIG. 4 is a diagram illustrating an example label, example packaging, and an example product fact sheet, each containing visual indications for using an aqueous-iodine-containing spray device.

### DETAILED DESCRIPTION

Dissolving crystalline iodine in water has been elusive over the past 200 years. However, it can now be accomplished in several ways, including the way describe in U.S. Pat. No. 6,139,731, “Iodinated Water Treatment Process”, issued on Oct. 31, 2000, to Harvey et al., which includes the present inventor. Maintaining the stability of iodine once dissolved in water is difficult; temperature, light, air, and wetted part material interactions all affect the shelf life and the integrity of aqueous iodine.

Current cosmetic and perfume type dispensing devices fabricated from plastic polymers that are resistant to iodine do not exist. The wetted parts of such dispensing devices, including the reservoir walls, drop tubes (or rising pistons in the case of airless bottles), sprayers (e.g., atomizers), and their seals within the devices, are fabricated from materials that absorb iodine and degrade quickly in the presence of iodine. Iodine has an affinity for plastic, and it passes through some plastics like it does air. There is no pure aqueous iodine spray on the market today at least in part because there is no spray bottle that functions properly in the presence of pure aqueous iodine.

In this connection, aspects of the present disclosure overcome the debilitating factors with conventional dispensing devices currently on the market as these factors relate to maintaining and dispensing pure aqueous iodine. More particularly, in some aspects the present disclosure is directed to methods of preparing, or “preconditioning,” spray devices for dispensing aqueous iodine for any of a variety of purposes, such as, orally administering iodine to humans and animals, topically administering iodine to humans and animals, and dispensing iodine for disinfecting surfaces and/or regions of space, and/or any other application that can benefit from any one or more of iodine's beneficial properties. In addition, some aspects of the present disclosure are directed to the spray devices themselves. Further, other aspects of the present disclosure are directed to methods of using an spray dispenser for dispensing aqueous iodine, for any one or more of a variety of purposes, such as the purposes noted above. Each of the foregoing and other aspects are described below using non-limiting examples.

In some embodiments, it is economically advantageous that spray devices for aqueous iodine be constructed of at least one material that absorbs iodine through surfaces wetted by the aqueous iodine during deployment for use. This is so because spray devices made only of materials highly resistant to adsorption of iodine in the aqueous iodine can be, relatively, so expensive that using them as means of delivering iodine may not commercially viable. However, utilizing spray devices made of materials that relatively readily absorb iodine, including conventional spray devices used in other industries, such as the cosmetics industry and the perfume industry, but modified as disclosed herein, can provide highly economical means for delivering iodine via an aqueous solution.

Since various materials of which economical aqueous iodine dispensing devices may be made absorb iodine in their unaltered states, using such dispensing devices without conditioning has any one or more undesirable effects when the dispensing device is filled with aqueous iodine. For example, when an unconditioned spray device is filled with an aqueous iodine having a precise iodine concentration, for example, for human nutritional supplementation or topical application, the iodine-absorptive material(s) will absorb some amount of iodine from the aqueous iodine, thereby changing the iodine concentration in the aqueous iodine such that the iodine concentration is no longer the precise desired value. In addition, absorption of iodine by such materials generally varies with temperature, and differing spray devices can be exposed to differing temperatures and temperature fluctuations over its useful life. Consequently, the true concentration of iodine in the aqueous iodine may differ significantly by varying amount from the desired or claimed concentration. Because of this, people following any provided dosing directions, in fact, will not be getting the recommended dosage. In addition, some economical materials having low resistance to iodine may not be usable at all because the iodine can pass completely through them.

A solution to these issues relating to iodine-absorption is to precondition spray devices that will be used as aqueous-iodine dispensers. At a high level, preconditioning involves, among other things, exposing all surfaces of the iodine-absorptive material(s) of the spray device that will eventually be wetted by the aqueous iodine during deployed use to an iodine-containing conditioning agent to force the iodine-absorptive material(s) to absorb a desired amount of iodine from the iodine-containing conditioning agent. Generally, the desired amount of iodine absorbed by the iodine-absorptive material(s) is an amount that is at least equal to the amount that the iodine-absorptive material(s) would have absorbed from the aqueous iodine under a worst- or design-case time and temperature scenario. By doing so, once the spray device has been conditioned and then filled with aqueous iodine, the iodine-absorptive material(s) will already contain adsorbed iodine from the iodine-containing conditioning agent and, therefore, will generally not absorb iodine from the aqueous iodine. Consequently, there will be little to no iodine absorption that changes the iodine concentration in the aqueous iodine, and the iodine concentration will remain at its intended precise level. As will be seen below, preconditioning may include additional steps, depending on the exact configuration and construction of the spray device at issue.

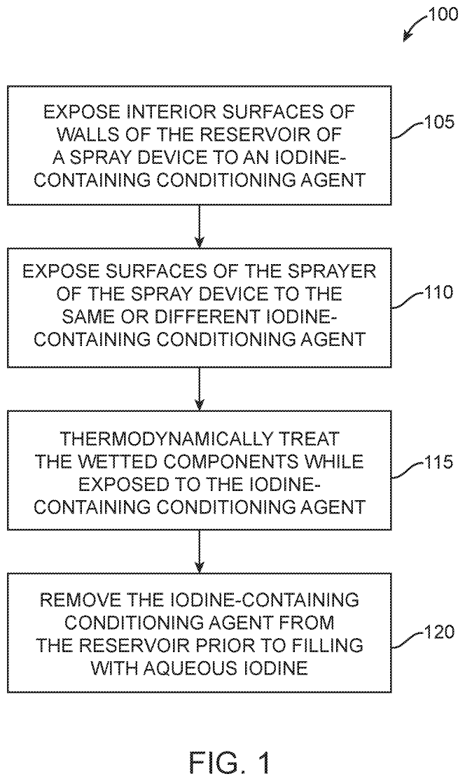

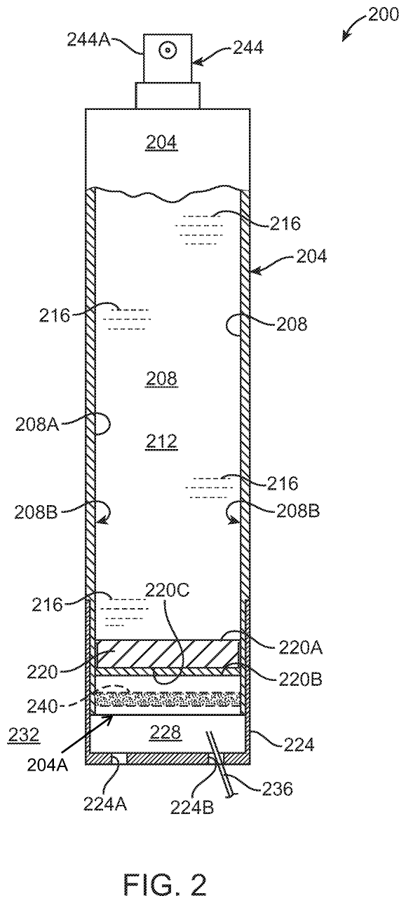

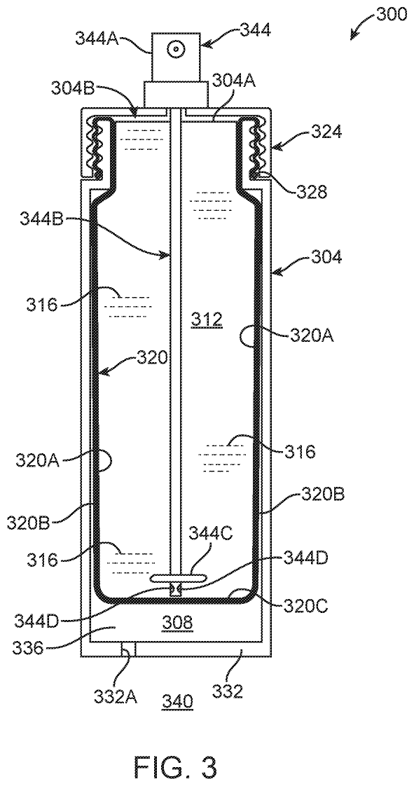

To illustrate aspects of spray-device preconditioning in more detail, attention is directed to FIG. 1, which portrays an example method 100 of preparing a spray device for dispensing aqueous iodine. In some embodiments, the spray device may be an airless spray device, such as a piston-type airless spray device or a bag-type spray device. Generally, an airless spray device is a spray device that does not allow air to contact the aqueous iodine contained in a reservoir inside the spray device. A piston-type airless spray device includes a piston that seals one end of the reservoir and moves as aqueous iodine within the reservoir is pumped from the reservoir by a suitable sprayer, such as an atomizer. A piston-type airless spray device typically includes an air chamber on the side of the piston opposite the reservoir, that air chamber is either open to or vented to ambient pressure surrounding the spray device to keep the pressure within the air chamber equalized with the ambient pressure. In this manner, the piston can move freely to compensate for the aqueous iodine dispensed from the reservoir. A bag-type airless spray device utilizes a bag to define the reservoir for the aqueous iodine, and the bag is typically contained in a chamber within the spray device. Similar to a piston-type airless spray device, a bag-type airless spray device typically includes an air chamber open to or otherwise vented to ambient pressure surrounding the spray device so as to allow the bag to freely collapse as aqueous iodine is pumped from the reservoir internal to the bag. Detailed examples of a piston-type airless spray device 200 and a bag-type airless spray device 300 are illustrated, respectively, in FIGS. 2 and 3.

When the spray device is assembled, it includes a body that defines a chamber and contains a reservoir for holding the aqueous iodine when the spray device is filled for use. The reservoir comprises walls that have interior surfaces wetted by the aqueous iodine when the aqueous iodine is present in the reservoir. When the spray device is assembled, a sprayer, such as an atomizer, among other types, is in fluid communication with the reservoir and has surfaces wetted by the aqueous iodine during use of the spray device. These and other components of example piston-type and bag-type airless spray devices 200, 300 are described below in connection with FIGS. 2 and 3, respectively.

Referring again to FIG. 1, at block 105 of method 100 interior surfaces of the walls of the reservoir are exposed to a iodine-containing conditioning agent. Iodine-containing conditioning agent may be any iodine-containing fluid that contains iodine that can be absorbed by the walls of the reservoir. In one example, the iodine-containing conditioning agent comprises an aqueous iodine solution having an iodine concentration in a range of 2 parts per million (ppm) to 300 ppm. In other embodiments, the aqueous iodine solution used as the iodine-containing conditioning agent may have a concentration of more than 300 ppm. In another example, the iodine-containing conditioning agent may be a gaseous iodine that is injected into the reservoir so as to perform the same function as the aqueous iodine mentioned above or other liquid iodine-containing conditioning agent.

In some embodiments, the iodine concentration of the iodine-containing conditioning agent may be selected based on the material of which the walls of the reservoir is made. For example, some plastics, such as polyethylene readily absorbs iodine, such that the concentration of the iodine in the iodine-containing conditioning agent may be lower than for other materials, such as an acrylic polymer, polytetrafluoroethylene (PTFE), and acrylonitrile butadiene styrene (ABS), among others.

In some embodiments, the interior surfaces of the walls of the reservoir may be exposed to the iodine-containing conditioning agent by filling the reservoir with the iodine-containing conditioning agent. In some embodiments, the interior surfaces of the walls of the reservoir may be exposed to the iodine-containing conditioning agent by immersing the body of the spray device in the iodine-containing conditioning agent such that the reservoir fills with the iodine-containing conditioning agent. It is important that at least the interior walls of the reservoir that will be wetted by the aqueous iodine that the spray device is designed to hold are fully exposed to the iodine-containing conditioning agent. Generally, exposing exterior walls of the spray device to the iodine-containing conditioning agent is acceptable if needed for a particular preconditioning regime selected.

Exposing of the interior surfaces of the walls of the reservoir to the iodine-containing conditioning agent may be accomplished when the spray device is fully assembled, partially assembled, or fully disassembled, as desired to suit a particular processing regime. In the context of a piston-type airless spray device, in the fully assembled state and some partially assembled states, the piston may be present and in its location that corresponds to the maximum capacity of the reservoir. In such assembly states, the piston may be exposed to the iodine-containing conditioning agent simultaneously with the interior surfaces of the walls of the reservoir, for example, by filling the reservoir with the iodine-containing conditioning agent or immersing the body of the spray device, with the reservoir open at an end spaced from the piston, in the iodine-containing conditioning agent. If when the spray device is in the fully disassembled state or a partially assembled state in which the piston is removed from the body, both the interior surfaces of the walls of the reservoir and the piston may be exposed to the iodine-containing conditioning agent, for example, by immersion in the iodine-containing conditioning agent.

As another example, when the spray device is a bag-type airless spray device, the interior surfaces of the walls of the reservoir, i.e., the interior surfaces of the bag, that will be wetted with the aqueous iodine in the finished and filled spray device, can be exposed to the iodine-containing conditioning agent, for example, when the bag is installed in the chamber of the body of the spray device or when the bag is not present in the chamber. Various filling or immersion techniques can be used to expose at least the interior surfaces of the walls of the reservoir to the iodine-containing conditioning agent.

At block 110, surfaces of the sprayer that will be wetted by the aqueous iodine during deployed use of the spray device are exposed to the iodine-containing conditioning agent or a different iodine-containing conditioning agent. As with the reservoir, this conditioning can be done in situ when the spray device is fully or partially assembled or it can be done ex situ when it is removed from the spray device. In some embodiments, the sprayer may be a conventional pump-type sprayer by which pushing the sprayer toward the body of the spray device draws the liquid in the reservoir from the reservoir and forces it through a passageway internal to the sprayer and then out a nozzle to create a spray, such as an atomized spray. In such embodiments, exposing the surfaces of the sprayer that will eventually be wetted by the aqueous iodine to the iodine-containing conditioning agent may involve actuating the sprayer enough times, while the drawing end of the sprayer is immersed in the iodine-containing conditioning agent, that all relevant surfaces of the sprayer are wetted by the iodine-containing conditioning agent. In some embodiments, this may be done with the sprayer attached to the body of the spray device and the reservoir containing the iodine-containing conditioning agent.

At block 115, wetted components of the spray device are thermodynamically treated while they are exposed to the iodine-containing conditioning agent. This thermodynamic treatment is used to accelerate the iodine-absorption process such that iodine-absorbing material(s) absorb more iodine over a shorter period of time. During thermodynamic treatment, iodine is released from the iodine-containing conditioning agent and embeds itself into the wetted iodine-absorptive material(s), which satisfies natural chemical demand of such material(s) for the iodine present. This reduced any further future action between the later deployed aqueous iodine and the iodine-absorptive material(s) once the thermodynamic process is complete. In some embodiments, the body and/or sprayer are placed into a chamber of a thermodynamic-treatment system for the thermodynamic conditioning. Examples of thermodynamic-treatment systems include radiant-type systems and convection-type systems. Depending on the material(s) from which the body and sprayer are constructed, a radiant-type system can be desirable because, in general, only the object is heated, such that issues cause by hot surfaces and hot air within the chamber.

In some embodiments, the body and sprayer are thermodynamically treated at a temperature of at least 100° F. (˜37.8° C.) for a period of at least 12 hours. Those skilled in the art will readily understand that the temperature and time for thermodynamic treatment will vary as a function of a variety of parameters, such as the type(s) of iodine-absorbing material(s) being treated, the desired amount of iodine to be absorbed, the concentration of the iodine in the iodine-containing conditioning agent, and ability of the iodine in the iodine-containing conditioning agent to dissociate from the iodine-containing conditioning agent. In one example in which the walls of the reservoir are made of an acrylic thermoplastic and the sprayer is made of a polypropylene thermoplastic, the thermodynamic conditioning was conducted at 200° F. (˜93.3° C.) for a period of 48 hours.

At block 120, the iodine-containing conditioning agent is removed from the reservoir prior to filling the reservoir with the aqueous iodine that will be deployed with the spray device for ultimate use. In embodiments in which the reservoir was filled with the iodine-containing conditioning agent, removing the iodine-containing conditioning agent may include pouring the iodine-containing conditioning agent from the reservoir or pumping the iodine-containing conditioning agent from the reservoir. Optionally, the iodine-containing conditioning agent may be removed from passageways within the sprayer, for example, by pumping aqueous iodine, such as the aqueous iodine that will be deployed for use, through the sprayer.

Depending on the construction of a particular spray device and/or the construction material(s) of any additional components that may be present and wetted by the aqueous solution during deployment of the spray device, additional steps can be used to condition the spray device. For example, if the spray device is a piston-type airless spray device that includes an internal piston that moves when the aqueous iodine within the reservoir is pumped out during actuation of the sprayer, the piston may be wetted by the aqueous iodine and be constructed of a material that is not resistant to iodine, i.e., that would absorbs iodine from the aqueous iodine and/or allow the iodine to pass through the piston. In this case, the piston can be preconditioned using the above process that includes exposing the reservoir, which now includes an interior surface of the piston, to the iodine-containing conditioning agent.

In addition, to prevent iodine from passing through and beyond the piston when the piston is made of one or more particularly iodine-non-resistant materials such as a polyethylene polymer, the side of the piston facing away from the reservoir may be coated with a suitable iodine-resistant material to provide a barrier to iodine. Examples of iodine-resistant materials that can be used to provide that barrier include, but are not limited to, a polyvinyl difluoride polymer, a fluoropolymer elastomer, a polytetrafluoroethylene polymer, and glass, among others. The piston may be provided with such a barrier either in situ or ex situ, depending on the desired manner of producing the spray device.

As an example of providing an iodine barrier while the piston is in situ, the spray device may include a closure secured to the body adjacent to the piston-end of the reservoir so as to form an air chamber. The closure may include a pressure-equalization aperture (see, e.g., pressure-equalization aperture 224A of spray device 200 of FIG. 2) that allows the air pressure within the air chamber to equalize with the air pressure surrounding the spray device to allow the piston to move freely as a user pumps aqueous iodine from the reservoir. When the closure is secured to the body of the spray device, access to the side of piston facing away from the reservoir is restricted to the sole pressure-equalization aperture. A needle-type spray device for spray-applying the barrier material can be inserted through the pressure-equalization aperture. However, ensuring a uniform and continuous barrier can be challenging, particularly when the needle occupies virtually the entire area of the pressure-equalization aperture such that air and/or other gas(es) used for the spraying cannot properly exhaust through the pressure-equalization aperture during spraying. Consequently, at least one additional aperture may be provided to closure to allow the insertion of the spray needle and to permit proper exhausting of gases from the air chamber during the spray-coating process. It is noted that the barrier can be applied to piston in situ with closure not present. Ex situ application of barrier can proceed in any suitable manner prior to inserting the piston into the chamber of the body to close the reservoir.

The iodine concentration of the aqueous iodine deployed with the spray device for use may be any concentration suitable for the particular application at issue. Generally, the concentration will typically be in a range from 2 ppm to 300 ppm, corresponding to an iodine content of 0.02% to 0.3% by weight, respectively, although it can be higher or lower. Typically, the concentration will be lower than 500 ppm because outgassing of the iodine can occur under temperature and pressure conditions that can occur under in daily environments. Some examples of iodine concentrations that may be used include, but are not limited to 5 ppm, 10 ppm, 20 ppm, 50 ppm, 75 ppm, 100 ppm, 150 ppm, 200 ppm, 250 ppm, and 300 ppm, among others.

As noted above, the iodine concentration of the aqueous iodine can determine the amount of absorbed iodine desired to be present in the iodine-absorptive material(s) that will be wetted by the aqueous iodine during use of the spray device, and the amount of absorbed iodine can vary based on the iodine-absorptive material(s) used. In some embodiments, the amount of absorbed iodine desired to be present in the iodine-absorptive materials is 0.002% or more for PTFE, 0.01% or more for polyethylene, and 0.005% or more for polypropylene, for a planned aqueous iodine having a concentration of 300 ppm. Other amounts of absorbed iodine may be lower or higher for other materials and/or other iodine concentrations of aqueous iodine to be deployed for use.

Some aspects of the present disclosure are directed to spray devices having components that have been preconditioned to resist depleting iodine in aqueous iodine deployed for use in the spray devices. In some embodiments, the preconditioning can occur according to example method 100 of FIG. 1 or suitable variation thereof. Following are examples of two such spray devices, namely, piston-type airless spray device 200 (FIG. 2) and bag-type airless spray device 300 (FIG. 3).

Referring now to FIG. 2, in this example piston-type airless sprayer 200 includes a body 204 that defines a chamber 208 and contains a reservoir 212 for holding aqueous iodine, as illustrated by intermittent hatching 216 for convenience. In this embodiment, reservoir 208 is defined by interior surfaces 208A of walls 208B of chamber 208 and an interior surface 220A of a piston 220. Piston 220 sealingly engages walls 208B of chamber 208 so as to fluidly seal reservoir 212. Also in this embodiment, piston-type airless sprayer 200 includes a closure 224 may be monolithically integrated with body 204 or formed separately and secured to the body using any suitable means as shown. Closure 224 defines an air chamber 228 on the side of piston 220 opposite reservoir 212. In this example, closure 224 includes a single pressure-equalization aperture 224A for equalizing pressure between air chamber 228 and the ambient environment 232 surrounding piston-type airless sprayer 200. Also in this example, piston-type airless sprayer 200 includes a spray aperture 224B for spray-applying an optional barrier 220B onto face 220C of piston 220. The purpose of barrier 220B is discussed above. Spray aperture 224B can be used for receiving a sprayer needle 236 used to spray-apply barrier 220B. In this case, pressure-equalization aperture 224A may function as an exhaust port for exhausting any gasses from the spray-application process. Alternatively, pressure-equalization aperture 224A may be used to receive sprayer needle 236 and spray aperture 224B may function as the exhaust port. In other embodiments, more apertures and/or other types, sizes, and locations of apertures can be provided to suit a particular design.

Piston-type airless spray device 200 may optionally include activated carbon 240 placed within air chamber 228. In one example, activated carbon 240 is provided in the form of a disk. Activated carbon 240 may be provided to ensure that any iodine leakage past and/or through piston 220 is captured before exiting air chamber 228. Activated carbon 240 has characteristics that capture iodine molecules both in liquid and gaseous forms.

Piston-type airless spray device 200 also includes a sprayer 244 in fluid communication with reservoir 212. Sprayer 244 may be of the atomizing type and includes one or more internal passageways (not shown) and any other components (not shown) necessary for operation, such as a spring mechanism that urges a movable spray head 244A into a non-actuated position. Sprayers suitable for use as sprayer 244 are well known in the art, such that further explanation is not necessary for those skilled in the art to broadly enable a wide variety of spray devices using the present disclosure as a guide.

As a particular example of piston-type airless spray device 200, the materials of various components of the spray device may be as follows. Body 204 may comprise, for example, an acrylic polymer, polyethylene, ABS, or the like, sprayer 244 may comprise a hard plastic, piston 220 may comprises a soft polymer, and closure 224 may be made of plastic and/or metal. The iodine content of body 204, sprayer 244, and piston 220 adjacent to the corresponding to the surfaces to be wetted by aqueous iodine 216 may be as described above. These iodine contents may be achieved, for example, using any of the methods described above, including method 100 of FIG. 1. Of course, these iodine contents are present prior to reservoir 212 being filled with aqueous iodine 216. It is also noted that aqueous iodine 216 may be of any suitable concentration, such as any of the concentrations described above. A cap (not shown) may be provided for covering sprayer 244 when not in use. The volume of reservoir 212 may be any suitable volume, such as for example, 25 ml, 50 ml, 75 ml, and 100 ml, among many others.

In another example, closure 228 and body 204 may be monolithically integrated with one another and made of glass. In this example, the throat 204A of body 204 may be of sufficient size to allow piston 220 to be inserted into chamber 208 via this throat and then pushed into position within the chamber prior to filling reservoir 212. In this example, pressure-equalizing aperture 224A and spray aperture 224B, if provided, may be formed in the glass of closure 224 to allow for piston movement upon actuation of sprayer 244. Having body 204 fabricated from glass reduces the component pretreatment process to sprayer 244 and/or piston 220, as glass is not affected by iodine at a molecular level. Piston 220 may be preconditioned and/or provided with barrier 220A as needed in any of the manner discussed above. In addition, activated carbon 240 may be inserted into chamber 208 prior to inserting piston 220.

Referring now to FIG. 3, in this example bag-type airless sprayer 300 includes a body 304 that defines a chamber 308 and contains a reservoir 312 for holding aqueous iodine as illustrated by intermittent hatching 316 for convenience. In this embodiment, reservoir 312 is defined by interior surfaces 320A of walls 320B of a collapsible bag 320 contained within chamber 308. In this example, body 304 has an opening 304A at one end 304B, which is designed and configured to receive a first closure 324 that closes end 304B of the body. First closure 324 and end 304B of body 304 are designed and configured for securing the first closure to the body, such as via threads, snap fit, interference fit, or other attachment means. In some embodiments, bag 320 may be held in place using an elastic O-ring seal 328 prior to first closure 324 being secured to body 304. Then, when first closure 324 is engaged with body 308, the capturing of portions of bag 320 between the first closure and the body to effect a permanent seal.

Also in this embodiment, bag-type airless sprayer 300 may include a second closure 332 that may be monolithically integral with body 304 as shown or formed separately from the body and secured thereto using any suitable means. Second closure 332 closes chamber 308 and may further define an air chamber 336 between bag 320 and the second closure. In this example, second closure 332 includes at least one pressure-equalization aperture 332A for equalizing pressure between air chamber 336 and the ambient environment 340 surrounding bag-type airless sprayer 300.

Bag-type airless spray device 300 also includes a sprayer 344 in fluid communication with reservoir 312. In some embodiments, sprayer 344 may be integrated with first closure 324. Sprayer 344 may be of the atomizing type and includes one or more internal passageways (not shown) and any other components (not shown) necessary for operation, such as a spring mechanism that urges a movable spray head 344A into a non-actuated position. In some embodiments, sprayer 344 may include a draw tube 344B that extends proximate to a distal end 320C of bag 320. In order to reduce fouling of draw tube 344B by bag 320 as it collapses during operation of bag-type airless spray device 300, spray device 344 may include a disk 344C the end of draw tube 344B distal from spray head 344A to ensure sufficient distance between the bag insert and the draw tube to allow fluid flow. Draw tube 344B may also include perforated holes 334D on its distal end to reduce the incidence of flow blockage by bag 320 while collapsing. Some sprayer components suitable for use in sprayer 344 are well known in the art, such that further explanation is not necessary for those skilled in the art to broadly enable a wide variety of spray devices using the present disclosure as a guide.

As a particular example of bag-type airless spray device 300, the materials of various components of the spray device may be as follows. Body 304 may comprise glass (which is highly resistant to iodine), sprayer 344 may comprise a hard plastic, and bag 320 may be made of a polymer, such as PTFE. It is noted that PTFE is resistant to iodine. However, although chemically inert plastics such as PTFE claim resistance to iodine, there is action at a molecular level that is visible in discoloration of the plastic. Therefore, preconditioning of bag 320 when made of such plastic is not necessarily negated. The iodine content of sprayer 344 and bag 320 adjacent to the corresponding to the surfaces to be wetted by aqueous iodine 316 may be as described above. These iodine contents may be achieved, for example, using any of the methods described above, including method 100 of FIG. 1. Of course, these iodine contents are present prior to reservoir 312 being filled with aqueous iodine 316. It is also noted that aqueous iodine 316 may be of any suitable concentration, such as any of the concentrations described above. A cap (not shown) may be provided for covering sprayer 344 when not in use. The volume of reservoir 312 may be any suitable volume, such as for example, 25 ml, 50 ml, 75 ml, and 100 ml, among many others.

In other embodiments, all components of the spray device wetted by the deployed aqueous iodine, such as the sprayer, body (when defining the reservoir), collapsible bag (when defining the reservoir, the piston (when present), may be made of one or more iodine-resistant or iodine-inert materials, such as, but not limited to, a polyvinyl difluoride polymer, a fluoropolymer elastomer, a polytetrafluoroethylene polymer, and glass, among others, that may additionally provide minimal light transference through the various components. Examples of such wetted components are described above, including in connection with FIGS. 2 and 3. Each of the components described there can be made of one or more iodine-resistant or iodine-inert materials. Even materials classified as chemically resistant/inert do have affinity for iodine, such that preconditioning in accordance with the present disclosure, such as via method 100 of FIG. 1 is desirable.

Regardless of the material(s) of construction for any particular spray device, preconditioned spray devices of the present disclosure provide spray devices that will allow for improved product shelf life, little or no degradation of the aqueous iodine by way of material interaction, and no degradation of aqueous iodine due to sublimation from the solution. Overall, aspects of the present invention provide spray devices that will withstand the demands of the aqueous iodine.

Aspects of the present disclosure provide for a predetermined dose of aqueous iodine to be applied by way of a spray device, such as any one of the spray devices described herein. In some embodiments, a spray device of the present disclosure produces a mist spray of pure aqueous iodine when the sprayer is actuated, for example, depressed. Such a spray device may be used, for example, for oral applications as a micronutrient and/or topical skin applications providing microbial effects and/or enhancing cellular health. Topical applications to epidermis can perform biocidal activity upon the epidermis to combat skin disease such as acne, cold sores, wrinkles and scar tissue, and through osmosis as an essential daily micronutrient to the human body. Iodine is absorbed through the skin and metabolized through the bloodstream.

In addition, embodiments of spray devices of the present disclosure can provide for a predetermined iodine-dose mist sprays for agriculture applications. For example, such embodiments can be utilized to apply aqueous iodine on plants, fruit, meat, and vegetable in residential and commercial applications. They can also be used to deliver aqueous iodine as a biocide applied to soil biocide and/or as a soil micronutrient and/or as general disinfectant spray to name but a few applications.

In this connection, some aspects of the present disclosure are directed to methods of assisting a user with administering iodine, for example, for any one or more of the purposes noted above, including nutritional supplementation, oral and/or topical) and disinfecting, among many others. To facilitate proper dosing, the deployed aqueous iodine needs to have a known, stable iodine concentration, which a spray device of the present disclosure, such as any of the preconditioned spray devices described above, including spray devices 200 and 300 of FIGS. 2 and 3, can provide. For a spray device having a manually actuated pump-type sprayer, the volume of aqueous iodine dispensed with each full actuation (e.g., depression) of the sprayer can be acquired. Based on the known iodine concentration and the volume of aqueous iodine dispensed with each full actuation of the sprayer, the amount of iodine dispensed with each activation can be determined. Then, based on a recommended dosage to be administered, such as a daily dosage or dosage at a particular time, the number of activations of the sprayer can be determined.

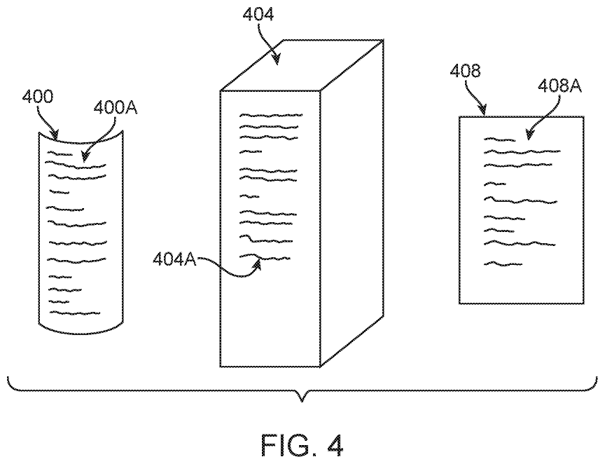

Referring to FIG. 4, such dosage information can be provided to a user in an suitable manner, such as by providing suitable visual indications, such as visual indications 400A, 404A, 408A, containing at least one of a fixed amount of aqueous iodine dispensed per each full activation of the sprayer, a recommended dosage, an amount of iodine dispensed per each full activation of the sprayer, and a number of full activations of the sprayer that corresponds to the recommended dosage. In the three examples shown in FIG. 4, visual indications 400A, 404A, and 408A are provided on, respectively, a label 400 that is applied to a corresponding spray device (not shown), packaging 404 in which a spray device is sold or otherwise provided, and a fact sheet 408 provided with a spray device. In each of these examples, the spray device at issue may be any of the spray devices disclosed herein, including spray devices 200 and 300 of FIGS. 2 and 3. Visual indications 400A, 404A, and 408A will typically be provided in print form for reading by the user and may be provided with any other information useful to the user for apply the dosage properly.

In an example of visual indications 400A, 404A, and 408A for applying the aqueous iodine to treat human skin, each of the visual indications may be as follows: “Apply 2-4 full pump sprays to the area to be treated. Allow product to air dry on skin. Apply 15 minutes before bedtime or before applying any other skin-care product.” In this example, the number of indicated full pumps of the sprayer is determined as a function of a recommended dosage, the iodine concentration of the aqueous iodine, and the volume of aqueous iodine dispensed per full pump.

In an example of visual indications 400A, 404A, and 408A for orally dosing the aqueous iodine as a micronutrient, each of the visual indications may be as follows: “Each full pump dispenses 25 micrograms (mcg) of iodine. Recommended supplement dosages: Adults: 150 mcg; Children 1-8: 90 mcg; Pregnant Women: 220 mcg; Lactating Women: 290 mcg.” In this example, the amount of iodine dispensed per full pump of the sprayer is determined by the iodine concentration of the aqueous iodine and the volume of aqueous iodine dispensed per each full pump of the sprayer. The user can then determine the number of pumps to make by dividing the appropriate recommended dosage by the amount of iodine dispense. For example, for an adult, the number of pumps equals 150 mcg/25 mcg per full pump=6 full pumps.

These examples are merely illustrative and non-limiting. Those skilled in the art will readily be able to determine the appropriate visual indications for the application at hand.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of preparing a spray device for dispensing aqueous iodine, when assembled the spray device comprising:
a body defining a chamber and containing a reservoir for holding the aqueous iodine, wherein the reservoir comprises walls having interior surfaces wetted by the aqueous iodine when the aqueous iodine is present in the reservoir; and
a sprayer in fluid communication with the reservoir, the sprayer having surfaces wetted by the aqueous iodine during use of the spray device when the aqueous iodine is present in the reservoir;
the method comprising:
exposing the interior surfaces of the walls of the reservoir to an iodine-containing conditioning agent;
exposing the surfaces of the sprayer, to the iodine-containing conditioning agent;
thermodynamically treating the body and the sprayer while the interior surfaces of the reservoir and the surfaces of the sprayer are exposed to the iodine-containing conditioning agent; and
removing the iodine-containing conditioning agent from the reservoir prior to filling the reservoir with the aqueous iodine.

2. The method of claim 1, wherein the body has an open end and the spray device further comprises a piston sealing the reservoir relative to the open end and providing at least one of the walls of the reservoir.

3. The method of claim 2, wherein the piston has a face opposite the reservoir, the method further comprising providing activated carbon adjacent to the face of the piston.

4. The method of claim 2, further comprising coating a face of the piston with an iodine-resistant material that provides a physical barrier to iodine in the aqueous iodine when the spray device is assembled and the aqueous iodine is in the reservoir.

5. The method of claim 4, wherein coating the face of the piston is performed when the piston is disposed in the body so as to seal the reservoir at the open end.

6. The method of claim 5, wherein the face of the piston is facing away from the reservoir, and coating of the face of the piston is performed by spraying the iodine-resistant material onto the face of the piston.

7. The method of claim 6, wherein the spray device further comprises a closure secured to the body, located adjacent to the open end of the body, and defining an air chamber exposed to the face of the piston, and spraying the iodine-resistant material onto the face of the piston includes spraying the iodine-resistant material through a spray aperture in the closure.

8. The method of claim 7, wherein the closure includes a preexisting pressure-equalizing aperture for equalizing pressure between the air chamber and an environment surrounding the spay device, and the method further comprises adding the spray aperture to the closure.

9. The method of claim 4, wherein the piston comprises a polyethylene polymer.

10. The method of claim 4, wherein the iodine resistant-material consists essentially of a polyvinyl difluoride polymer.

11. The method of claim 4, wherein the iodine-resistant material consists essentially of a fluoropolymer elastomer.

12. The method of claim 4, wherein the iodine-resistant material consists essentially of a polytetrafluoroethylene polymer.

13. The method of claim 4, wherein the iodine-resistant material consists essentially of a glass.

14. The method of claim 1, wherein the aqueous iodine has an iodine content of 300 parts per million or lower.

15. The method of claim 14, wherein the iodine-containing conditioning agent comprises aqueous iodine having an iodine concentration of at least 2 parts-per million.

16. The method of claim 1, wherein the reservoir is defined by a bag located within the chamber of the body when the spray device is assembled.

17. The method of claim 16, wherein exposing the interior surfaces of the walls of the reservoir is performed with the bag removed from the chamber.

18. The method of claim 1, wherein exposing the interior surfaces of the body to the iodine-containing conditioning agent includes filling the reservoir with the iodine-containing conditioning agent when the spray device is assembled.

19. The method of claim 18, wherein exposing interior surfaces of the sprayer includes activating the sprayer to spray a portion of the iodine-containing conditioning agent from the reservoir.

20. The method of claim 1, further comprising, after removing the iodine-containing conditioning agent from the reservoir, filling the reservoir with aqueous iodine having an iodine content of 300 parts per million or lower.

21. The method of claim 1, wherein thermodynamically treating the body and the sprayer includes heating the body and the sprayer to a temperature of at least 100° F. ('37.8° C.).

22. The method of claim 21, wherein thermodynamically treating the body and the sprayer further includes holding the temperature for a period of at least 12 hours.

23. The method of claim 1, wherein the walls of the reservoir comprise an acrylate polymer.

24. The method of claim 1, wherein the walls of the reservoir comprise an acrylonitrile butadiene styrene polymer.

25. The method of claim 1, wherein the iodine-containing conditioning agent comprises gaseous iodine.

26. A spray device, comprising:
a body defining a chamber and containing a reservoir for holding aqueous iodine, wherein the reservoir has walls wetted by the aqueous iodine when the aqueous iodine is present in the reservoir, at least one of the walls comprising a polymer containing sorbed iodine from an iodine-containing preconditioning agent at least in regions adjacent to the reservoir; and
a sprayer having a fluid-passageway in fluid communication with the reservoir and wetted by the aqueous iodine when the aqueous iodine is present in the reservoir and the spray device is in use, the sprayer comprising a polymer containing sorbed iodine from the iodine-containing preconditioning agent at least in regions adjacent to the fluid passageway.

27. The spray device of claim 26, wherein the body has an open end and the spray device further comprises a piston sealing the reservoir relative to the open end and providing at least one of the walls of the reservoir.

28. The spray device of claim 27, wherein the piston has a face opposite the reservoir and the spray device further comprises activated carbon disposed proximate to the face of the piston.

29. The spray device of claim 27, wherein the piston includes a coating comprising an iodine-resistant material that provides a physical barrier to iodine in the reservoir when the spray device is assembled and aqueous iodine is present in the reservoir.

30. The spray device of claim 29, wherein the piston is made of the iodine-resistant material.

31. The spray device of claim 29, wherein the piston is made of a non-iodine-resistant material and the iodine-resistant material is applied to the piston.

32. The spray device of claim 31, further comprising a closure secured to the body, located adjacent to the open end of the body, and defining an air chamber exposed to the face of the piston, wherein the closure includes a pressure-equalization aperture equalizing pressure between the air chamber and an environment surrounding the spay device and a spray aperture spaced from the pressure equalization aperture, and wherein the iodine-resistant material is applied to the piston on the face of the piston.

33. The spray device of claim 31, wherein the iodine resistant-material consists essentially of a polyvinyl difluoride polymer.

34. The spray device of claim 31, wherein the iodine-resistant material consists essentially of a fluoropolymer elastomer.

35. The spray device of claim 31, wherein the iodine-resistant material consists essentially of a polytetrafluoroethylene.

36. The spray device of claim 31, wherein the iodine-resistant material consists essentially of a glass.

37. The spray device of claim 26, further comprising a bag located in the chamber and providing the walls of the reservoir.

38. The spray device of claim 26, wherein the body has an open end and the spray device further comprises a closure secured to the body, located adjacent to the open end of the body, and defining an air chamber exposed to the open end of the body, wherein the closure includes a pressure-equalization aperture equalizing pressure between the air chamber and an environment surrounding the spay device and a spray aperture spaced from the pressure equalization aperture.

39. The spray device of claim 26, further comprising an aqueous iodine contained within the reservoir.

40. The spray device of claim 39, wherein the aqueous iodine has an iodine content of 300 parts per million or lower.

41. The spray device of claim 26, wherein the sorbed iodine in the body is present in an amount of at least 50 parts per million.

42. The spray device of claim 41, wherein the sorbed iodine in the sprayer is present in an amount of at least 10 parts per million.

43.-61. (canceled)
